(19) United States
(12) Patent Application Publication
(10) Pub. No.: US 2007/0032956 A1
(43) Pub. Date: Feb. 8, 2007

(54) Fast T1 measurement by using driven equilibrium

(75) Inventors: Martin Blanz, Celle (DE); Andy Brooks, Tomball, TX (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated

(21) Appl. No.: 11/284,117

(22) Filed: Nov. 21, 2005

Related U.S. Application Data
(60) Provisional application No. 60/629,967, filed on Nov. 22, 2004.
(60) Provisional application No. 60/633,238, filed on Dec. 3, 2004.

(51) Int. Cl. G01V 1/28

(52) U.S. Cl. 702/14

(57) ABSTRACT

An amplitude of an echo signal in a driven equilibrium (DE) pulse group is used for determination of a longitudinal relaxation time T₁ of an earth formation. DE pulse groups followed by a CPMG sequence can be used for estimating both T₁ and a transverse relaxation time T₂ within one fast measurement.

### CROSS-REFERENCES TO RELATED APPLICATIONS

This application claims priority from U.S. Provisional Patent Application Ser. No. 60/629,967 filed on Nov. 22, 2004.

### BACKGROUND OF THE INVENTION

1. Field of the Invention

The present invention is related to methods of geological exploration in wellbores. In particular, the present invention is a method of improving nuclear magnetic resonance pulse techniques.

2. Description of the Related Art

A variety of techniques are currently utilized in determining the presence and estimation of quantities of hydrocarbons (oil and gas) in earth formations. These methods are designed to determine formation parameters, including among other things, the resistivity, porosity and permeability of the rock formation surrounding the wellbore drilled for recovering the hydrocarbons. Typically, the tools designed to provide the desired information are used to log the wellbore. Much of the logging is done after the wellbores have been drilled. More recently, wellbores have been logged while drilling, which is referred to as measurement-while-drilling (MWD) or logging-while-drilling (LWD). One advantage of MWD techniques is the reduced amount of time necessary to obtain information about the rock formation. Whereas there is a huge cost associated with the amount of time spent in oil exploration, reducing this amount of time is an important factor to consider when designing related testing methods and tools.

One recently evolving technique involves utilizing Nuclear Magnetic Resonance (NMR) logging tools and methods for determining, among other things, porosity, hydrocarbon saturation and permeability of the rock formations. The NMR logging tools are utilized to excite the nuclei of the liquids in the geological formations surrounding the wellbore so that certain parameters such as spin density, longitudinal relaxation time (generally referred to in the art as T₁) and transverse relaxation time (generally referred to as T₂) of the geological formations can be measured. From such measurements, porosity, permeability and hydrocarbon saturation are determined, which provides valuable information about the make-up of the geological formations and the amount of extractable hydrocarbons.

The NMR tools generate a static magnetic field in a region of interest surrounding the wellbore. NMR is based on the fact that the nuclei of many elements have angular momentum (spin) and a magnetic moment. The nuclei have a characteristic Larmor resonant frequency related to the magnitude of the magnetic field in their locality. Over time the nuclear spins align themselves along an externally applied magnetic field. This equilibrium situation can be disturbed by a pulse of an oscillating magnetic field, which tips the spins with resonant frequency within the bandwidth of the oscillating magnetic field away from the static field direction. The angle θ through which the spins exactly on resonance are tipped is given by the equation:
θ=γB₁tₚ (1)
where γ is the gyromagnetic ratio, B₁ is the effective field strength of the active rotating field component and tₚ is the duration of the RF pulse.

After tipping, the spins precess around the static field at a particular frequency known as the Larmor frequency ω₀, given by
ω=γB₀ (2)
where B₀ is the static field intensity. At the same time, the spins return to the equilibrium direction (i.e., aligned with the static field) according to an exponential decay time known as the spin-lattice relaxation time or T₁. For hydrogen nuclei, γ/2π=4258 Hz/Gauss, so that a static field of 235 Gauss would produce a precession frequency of 1 MHz. The T₁ of fluid in pores is controlled totally by the molecular environment and is typically ten to several thousand milliseconds in rocks.

At the end of a θ=90° tipping pulse, spins on resonance are pointed in a common direction perpendicular to the static field, and they precess at the Larmor frequency. However, because of inhomogeneity in the static field due to the constraints on tool shape, imperfect instrumentation, or microscopic material heterogeneities, each nuclear spin precesses at a slightly different rate. Hence, after a time long compared to the precession period, but shorter than T₁, the spins will no longer be precessing in phase. This de-phasing occurs with a time constant that is commonly referred to as T₂* if it is predominantly due to the static field inhomogeneity of the apparatus and as T₂ if it is due to properties of the material.

One method to create a series of spin echoes uses the so-called Carr-Purcell sequence. This method is discussed, for example, in Fukusima, E., and Roeder, B., “Experimental Pulse NMR: A Nuts and Bolts Approach”, 1981, as well as Slichter, C. P., “Principles of Magnetic Resonance”, 1990. The pulse sequence starts with a delay of several T₁ to allow spins to align along an applied static magnetic field axis. Then a 90° tipping pulse is applied to rotate the spins into the transverse plane, where they precess with angular frequency determined by local magnetic field strength. The spin system loses coherence in accordance with time constant, T₂*. After a short time (t_{CP}) a 180° tipping pulse is applied which continues to rotate the spins, inverting their position in the transverse plane. The spins continue to precess, but now their phases converge until they momentarily align a further time t_{CP} after application of the 180° pulse. The realigned spins induce a voltage in a nearby receiving coil, indicating a spin echo. Another 180° pulse is applied after a further time t_{CP,} and the process is repeated many times, thereby forming a series of spin echoes with spacing 2 t_{CP} between them.

While the Carr-Purcell sequence would appear to provide a solution to eliminating apparatus-induced inhomogeneities, it was found by Meiboom and Gill that if the duration of the 180° pulses in the Carr-Purcell sequence were even slightly erroneous so that focusing is incomplete, the transverse magnetization would steadily be rotated out of the transverse plane. As a result, substantial errors would enter the T₂ determination. Thus, Meiboom and Gill devised a modification to the Carr-Purcell pulse sequence (known as the CPMG sequence) such that after the spins are tipped by 90° and start to de-phase, the carrier of the 180° pulses is phase shifted by π/2 radians relative to the carrier of the 90° pulse. This phase change causes the spins to rotate about an axis perpendicular to both the static magnetic field axis and the axis of the tipping pulse. If the phase shift between tipping and refocusing pulses deviates slightly from π/2 then the rotation axis will not be perfectly orthogonal to the static and RF fields, but this has negligible effect. As a result any error that occurs during an even numbered pulse of the CPMG sequence is cancelled out by an opposing error in the odd numbered pulse. The CPMG sequence is therefore tolerant of imperfect spin tip angles. This is especially useful in a well logging tool which has inhomogeneous and imperfectly orthogonal static and pulse-oscillating (RF) magnetic fields. For an explanation, the reader is referred to a detailed account of spin-echo NMR techniques, such as in Fukushima and Roeder, “Experimental Pulse NMR: A Nuts and Bolts Approach”.

Other pulses sequences are known in the prior art. U.S. Pat. No. 6,466,013, to Hawkes et al., for example, discusses a method, referred to as the Optimized Rephasing Pulse Sequence (ORPS), which optimizes the timings for inhomogeneous B₀ and B₁ fields to obtain maximum NMR signal or, alternatively, to save radio frequency power. A pulsed RF field is applied which tips the spins on resonance by the desired tip angle for maximum signal, typically 90° tipping pulse. A refocusing pulse having a spin tip angle substantially less than 180° is applied with carrier phase shifted by typically π/2 radians with respect to the 90° tipping pulse. Although the refocusing pulses result in spin tip angles less than 180° through the sensitive volume, their RF bandwidth is closer to that of the original 90° pulse. Hence more of the nuclei originally tipped by 90° are refocused, resulting in larger echoes than would be obtained with a conventional 90° refocusing pulse. ORPS is not a CPMG sequence, since the timing and duration of RF pulses are altered from conventional CPMG to maximize signal and minimize RF power consumption. Nevertheless ORPS also possesses the characteristic that the tipping pulse is phase shifted by π/2 with respect to the refocusing pulses. An additional forced recovery pulse at the end of an echo train may be used to speed up the acquisition and/or provide a signal for canceling the ringing artifact. The forced recovery pulse occurs at the same time as the formation of an echo and acts about the same axis as the original 90° tipping pulse. The final pulse rotates the nuclear spins (that are in the process of forming the echo) away from the transverse (XY) plane and back into substantial alignment with the magnetic field. Since the final magnetization is in equilibrium with the static magnetic field, such a pulse sequence is often referred to as a Driven Equilibrium pulse sequence. It is shown by Edzes (“An analysis of the Use of Pulse Multiplets in the Single Scan Determination of Spin-Lattice Relaxation Rates”, J. Mag. Res., 17, 301-313 (1975)) that errors arising from inhomogeneities in the static and RF magnetic fields, from improper RF phases or from resonance offset, can largely be compensated by using a proper pulse multiplet, i.e. a driven equilibrium pulse sequence. Edzes also discusses a method of obtaining a spin-lattice relaxation constant using pulse multiplets evenly spaced in time after an inversion pulse.

The use of a driven equilibrium pulse sequence is discussed, for example, in U.S. Pat. No. 6,597,171, to Hurlimann et al. A sequence of magnetic pulses is applied to a fluid in a rock, the sequence including a first part that is designed to prepare a system of nuclear spins in the fluid in a driven equilibrium followed by a second part that is designed to generate a series of magnetic resonance signals. The first part can be a driven equilibrium pulse sequence. Repeated use of a driven equilibrium block results in an equilibrium magnetization that is dependent on T₁ and T₂. Combining such driven equilibrium blocks with the usual CPMG sequence gives the T₁ and T₂ of the sample. While Hurlimann '171 uses driven equilibrium pulses for preparation of a sample for T₁ or T₂ measurements, there is no discussion of using echo signals within the driven equilibrium sequence for directly determining formation and/or fluid properties.

U.S. Pat. No. 6,531,868, to Prammer, and U.S. Pat. No. 6,717,404, to Prammer, discusses a method of determining longitudinal relaxation times T₁ based on NMR relaxation time measurements using pulsed NMR tools with magnetic fields that are rotationally symmetric about the longitudinal axis of the borehole. At least one radio frequency pulse is generated covering a relatively wide range of frequencies to saturate the nuclear magnetization in a cylindrical volume around the tool; transmitting a readout pulse at a frequency near the center of the range of covered frequencies, the readout pulse following a predetermined wait time; applying at least one refocusing pulse following the readout pulse; receiving at least one NMR echo corresponding to the readout pulse; repeating the above steps for a different wait time to produce a plurality of data points on a T₁ relaxation curve; and processing the produced T₁ relaxation curve to derive petrophysical properties of the formation.

There is a general need for improving the speed at which one can obtain nuclear magnetic resonance data from a wellbore. The use of driven equilibrium pulses can address this need. The present invention satisfies that need.

### SUMMARY OF THE INVENTION

One embodiment of the present invention is a method of evaluating an earth formation. A driven-equilibrium (DE) pulse group is applied to the earth formation to generate at least one echo signal. A longitudinal relaxation time T₁ of the earth formation is estimated using an amplitude of the at least one echo signal. The at least one echo signal may be a plurality of echo signals. A plurality of DE groups may be applied after a saturation sequence to get a T₁ distribution. A T₁ distribution may also be obtained by applying a plurality of DE groups after an inversion sequence. After the sequence of DE groups a CPMG or ORPS sequence may follow to gather T₂ relaxation decay data from which a T₂ distribution can be estimated. The signals may be further processed to determine, porosity, clay bound water, bound water irreducible, bound water moveable, diffusivity and/or permeability.

Another embodiment of the invention is an apparatus for evaluating an earth formation. The apparatus includes a nuclear magnetic resonance (NMR) tool which applies at least one driven-equilibrium (DE) pulse group to the earth formation to generate at least one echo signal. A processor estimates a longitudinal relaxation time T₁ of the earth formation using an amplitude of the at least one echo signal. The at least one echo signal may comprises a plurality of echo signals. The at least one DE pulse group may have a plurality of DE pulse groups, and when the plurality of DE groups are applied subsequent to a saturation sequence a T₁ distribution may be estimated. A T₁ distribution may be obtained also be estimated by applying a plurality of DE groups following an inversion sequence. After the sequence of DE groups a CPMG or ORPS sequence may follow to gather T₂ relaxation decay data from which a T₂ distribution can be estimated. The processor may further estimate porosity, clay bound water, bound water irreducible, bound water moveable, diffusivity, and/or permeability. The NMR tool may be a zero gradient tool or one in which a static field gradient is present in a region of examination. The NMR tool may be on a bottomhole assembly (BHA) for drilling operations, or may be part of a downhole logging assembly conveyed on a wireline

Another embodiment of the invention is a machine readable medium having instructions of evaluation of an earth formation, the medium includes instructions for estimating a longitudinal relaxation time T₁ of the earth formation using an amplitude of at least one echo signal produced by applying at least one driven-equilibrium (DE) pulse group to the earth formation. With a plurality of echo signals, the medium further includes instructions for estimating a distribution of values of T₁. The medium may further include instructions for estimating porosity, clay bound water, bound water irreducible, bound water moveable, diffusivity and/or permeability. The medium may also include instructions for applying one or more DE pulse groups to the earth formation. The medium may also include instructions for applying pulse sequences including a plurality of DE groups, and processing the resulting signals to determine a T₂ distribution.

### BRIEF DESCRIPTION OF THE DRAWINGS

The present invention is best understood with reference to the accompanying figures in which like numerals refer to like elements and in which:

FIG. 1 (Prior Art) shows a measurement-while-drilling tool suitable for use with the present invention;

FIG. 1A (Prior Art) shows the antenna and magnet configuration of an exemplary NMR device suitable for use with the present invention;

FIG. 2 shows a typical driven equilibrium (DE) group;

FIGS. 3A-B show spin echo responses to a series of DE pulse groups

FIGS. 4A-B show spin echo responses to a series of DE pulse groups, each designed to give rise to three spin echoes;

FIG. 5A (prior art) shows a pulse sequence usable for a conventional saturation recovery T₁ method;

FIG. 5B (prior art) shows a pulse sequence for a conventional inversion recovery T₁ method;

FIG. 6A shows a pulse sequence for a fast saturation recovery T₁ method;

FIG. 6B shows a pulse sequence usable for a fast inversion recovery T₁ method;

FIG. 7A shows a pulse sequence that combines a fast saturation recovery T₁ method with a CPMG or ORPS sequence to also measure T₂ or a T₂ distribution; and

FIG. 7B shows a pulse sequence that combines a fast inversion recovery T, method with a CPMG or ORPS sequence to also measure T₂ or a T₂ distribution.

### DETAILED DESCRIPTION OF THE INVENTION

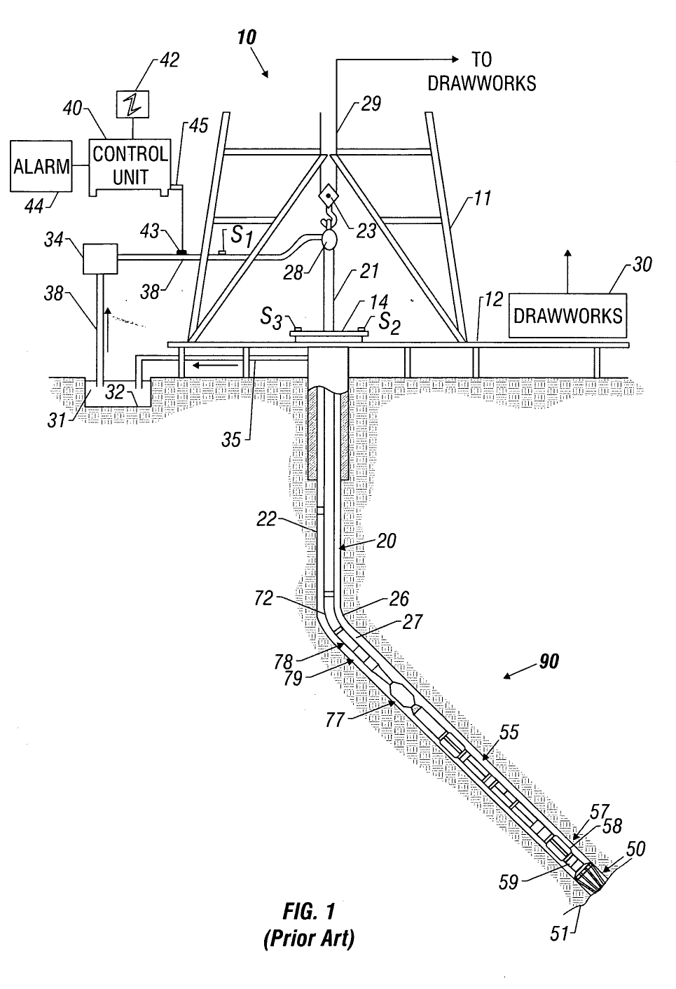

FIG. 1 shows a schematic diagram of a drilling system 10 with a drillstring 20 carrying a drilling assembly 90 (also referred to as the bottom hole assembly, or “BHA”) conveyed in a “wellbore” or “borehole” 26 for drilling the wellbore. The drilling system 10 includes a conventional derrick 11 erected on a floor 12 which supports a rotary table 14 that is rotated by a prime mover such as an electric motor (not shown) at a desired rotational speed. The drillstring 20 includes a tubing such as a drill pipe 22 or a coiled-tubing extending downward from the surface into the borehole 26. The drillstring 20 is pushed into the wellbore 26 when a drill pipe 22 is used as the tubing. For coiled-tubing applications, a tubing injector, such as an injector (not shown), however, is used to move the tubing from a source thereof, such as a reel (not shown), to the wellbore 26. The drill bit 50 attached to the end of the drillstring breaks up the geological formations when it is rotated to drill the borehole 26. If a drill pipe 22 is used, the drillstring 20 is coupled to a drawworks 30 via a Kelly joint 21, swivel 28, and line 29 through a pulley 23. During drilling operations, the drawworks 30 is operated to control the weight on bit, which is an important parameter that affects the rate of penetration. The operation of the drawworks is well known in the art and is thus not described in detail herein.

During drilling operations, a suitable drilling fluid 31 from a mud pit (source) 32 is circulated under pressure through a channel in the drillstring 20 by a mud pump 34. The drilling fluid passes from the mud pump 34 into the drillstring 20 via a desurger (not shown), fluid line 38 and Kelly joint 21. The drilling fluid 31 is discharged at the borehole bottom 51 through an opening in the drill bit 50. The drilling fluid 31 circulates uphole through the annular space 27 between the drillstring 20 and the borehole 26 and returns to the mud pit 32 via a return line 35. The drilling fluid acts to lubricate the drill bit 50 and to carry borehole cutting or chips away from the drill bit 50. A sensor S₁ typically placed in the line 38 provides information about the fluid flow rate. A surface torque sensor S₂ and a sensor S₃ associated with the drillstring 20 respectively provide information about the torque and rotational speed of the drillstring. Additionally, a sensor (not shown) associated with line 29 is used to provide the hook load of the drillstring 20.

In one embodiment of the invention, the drill bit 50 is rotated by only rotating the drill pipe 22. In another embodiment of the invention, a downhole motor 55 (mud motor) is disposed in the drilling assembly 90 to rotate the drill bit 50 and the drill pipe 22 is rotated usually to supplement the rotational power, if required, and to effect changes in the drilling direction.

In an exemplary embodiment of FIG. 1, the mud motor 55 is coupled to the drill bit 50 via a drive shaft (not shown) disposed in a bearing assembly 57. The mud motor rotates the drill bit 50 when the drilling fluid 31 passes through the mud motor 55 under pressure. The bearing assembly 57 supports the radial and axial forces of the drill bit. A stabilizer 58 coupled to the bearing assembly 57 acts as a centralizer for the lowermost portion of the mud motor assembly.

In one embodiment of the invention, a drilling sensor module 59 is placed near the drill bit 50. The drilling sensor module contains sensors, circuitry and processing software and algorithms relating to the dynamic drilling parameters. Such parameters typically include bit bounce, stick-slip of the drilling assembly, backward rotation, torque, shocks, borehole and annulus pressure, acceleration measurements and other measurements of the drill bit condition. A suitable telemetry or communication sub 72 using, for example, two-way telemetry, is also provided as illustrated in the drilling assembly 90. The drilling sensor module processes the sensor information and transmits it to the surface control unit 40 via the telemetry system 72.

The communication sub 72, a power unit 78 and an MWD tool 79 are all connected in tandem with the drillstring 20. Flex subs, for example, are used in connecting the MWD tool 79 in the drilling assembly 90. Such subs and tools form the bottom hole drilling assembly 90 between the drillstring 20 and the drill bit 50. The drilling assembly 90 makes various measurements including the pulsed nuclear magnetic resonance measurements while the borehole 26 is being drilled. The communication sub 72 obtains the signals and measurements and transfers the signals, using two-way telemetry, for example, to be processed on the surface. Alternatively, the signals can be processed using a downhole processor in the drilling assembly 90.

The surface control unit or processor 40 also receives signals from other downhole sensors and devices and signals from sensors S₁-S₃ and other sensors used in the system 10 and processes such signals according to programmed instructions provided to the surface control unit 40. The surface control unit 40 displays desired drilling parameters and other information on a display/monitor 42 utilized by an operator to control the drilling operations. The surface control unit 40 typically includes a computer or a microprocessor-based processing system, memory for storing programs or models and data, a recorder for recording data, and other peripherals. The control unit 40 is typically adapted to activate alarms 44 when certain unsafe or undesirable operating conditions occur.

The magnet and antenna configuration of an exemplary NMR device suitable for use with the present invention is shown in FIG. 1A. Magnets 132 and 134 are permanently magnetized, for example, in the axial direction and, in one embodiment, are positioned in opposing directions. Like magnetic poles, for example, the north magnetic poles of the two magnets 132 and 134 face one another for producing a toroidal region of substantially homogeneous radial magnetic field 140 perpendicular to the pair of axially aligned magnets 132 and 134. A radio frequency (RF) transmitting antenna or coil 136 is located, for example, between the two spaced-apart magnets 132 and 134. The RF coil 136 is connected to a suitable RF pulse transmitter for providing power at selected frequencies and a processor which determines a pulse sequence timing. The RF coil 136 is pulsed and creates a high frequency RF field orthogonal to the static magnetic field. The pulsed RF coil 136 creates the pulsed RF field 142 illustrated by dashed lines. The distance of the toroidal region 140 of homogeneous radial magnetic field from the axis of the magnets 132 and 134 is dependent upon the distance between like poles of the magnets 132 and 134. Rock pores (not shown) in the earth formations are filled with fluid, typically water or hydrocarbon. The hydrogen nuclei in the fluid are aligned in the region of homogeneous magnetic field 140, generated by the magnets 132 and 134. The hydrogen nuclei are then “flipped” away from the homogeneous magnetic field 140 by the pulsed RF field 142 that must fulfill the resonance condition (2) and is produced by RF coil 136. At the termination of the pulsed RF field from coil 136, the hydrogen nuclei revolve or precess at high frequency around the magnetic field 140 inducing an NMR signal in the RF coil 136. The induced NMR signals are sent to the surface for processing or can be processed by a downhole processor (not shown). Other variations for conducting NMR experiments would be known to those versed in the art, and any of these could be used in the application of the present invention. This basic structure is used, for example, in U.S. Pat. No. 6,215,304 to Slade, the contents of which are fully incorporated herein by reference.

The tool of Slade is what is called a “zero gradient” tool in which the static magnetic field gradient in the region of examination is close to zero. However, the method of the present invention may also be used with NMR tools that have field gradients. An example of such a device is shown in U.S. Pat. No. 6,348,792 to Beard et al., having the same assignee as the present invention and the contents of which are fully incorporated herein by reference.

Equilibrium in an NMR system is the state in which the affected nuclear spins are in equilibrium with the surrounding magnetic field and temperature. (i.e., parallel to the static external field, generally referred to as the z-axis). The actual magnetization can be manipulated by RF pulses to point along the z-axis using a method of “Driven Equilibrium”.

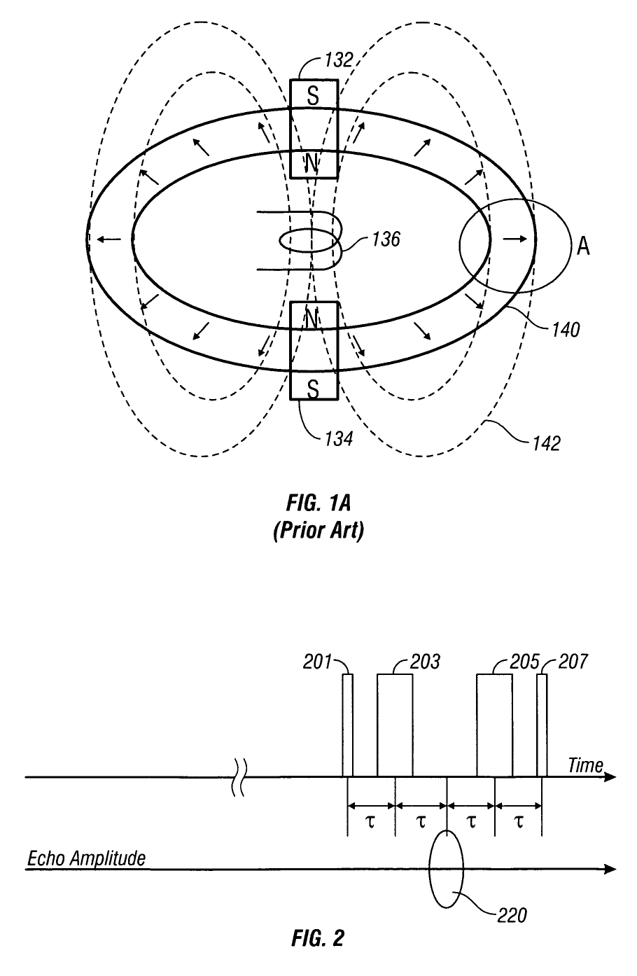

One example of a driven equilibrium (DE) group used in accordance with the present invention is shown in FIG. 2. A group of driven equilibrium RF pulses can be used to probe the z-magnetization by tipping it into the xy plane, generating an echo and tipping it back into the z direction. The DE group of FIG. 2 comprises the sequence:
90ₓ−τ−180_{y}−τ(echo)τ−180_{y}−τ−90₋ₓ. (3)
Following an initial long delay, that may be set in a typical application to 6 sec., a combination of 90ₓ tipping pulse 201 and 180_{y} refocusing pulse 203 (applied at a time τ after the tipping pulse) trigger a spin echo 220 in the acquisition window between 203 and 205. The dephasing spins are refocused using a second 180_{y} refocusing pulse 205. A time τ after the latter refocus pulse 205 the spins refocus again and at this time a 90₋ₓ recovery pulse 207 performs the opposite function of the initial 90ₓ tipping pulse 201 by flipping the magnetization back along the z direction. Approximately 80%-90% of the initial magnetization can be recovered in practice. It will be appreciated that other pulse sequences can be used in practice, such as replacing a signal acquisition window with a 90₋ₓ pulse following the second or subsequent echoes. It will be apparent to a person of skill in the art that different timing can be used in various practical applications as well.

The DE group, like the CPMG pulse sequence, corrects for cumulative pulse errors. In CPMG, cumulative pulse errors are compensated from the second echo of the primary echo train onward. In a DE group, the error from the 90ₓ pulse is also compensated. Consequently, the echoes of successive DE groups have the same amplitude. Minor differences in the amplitudes of echoes from successive DE groups are generally attributable to the presence of stimulated echoes. The use of the driven equilibrium concept in a “fast” saturation recovery sequence followed by a CPMG or ORPS enable one to obtain a T₁ decay (and by inversion a T₁ distribution) plus a T₂ decay (and by inversion a T₂ distribution) in the same amount of time in which a T₂ distribution alone is presently obtained. In the same manner, one can perform a “fast” inversion recovery sequence for T₁ measurements plus a T₂ measurement. This variant, however, needs an extra recovery wait time at the beginning of the sequence.

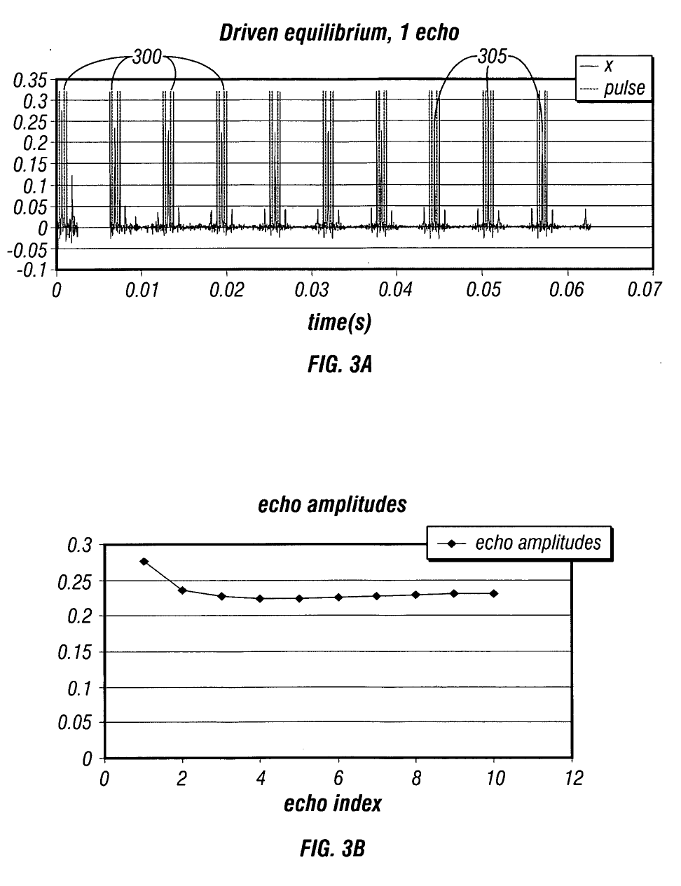

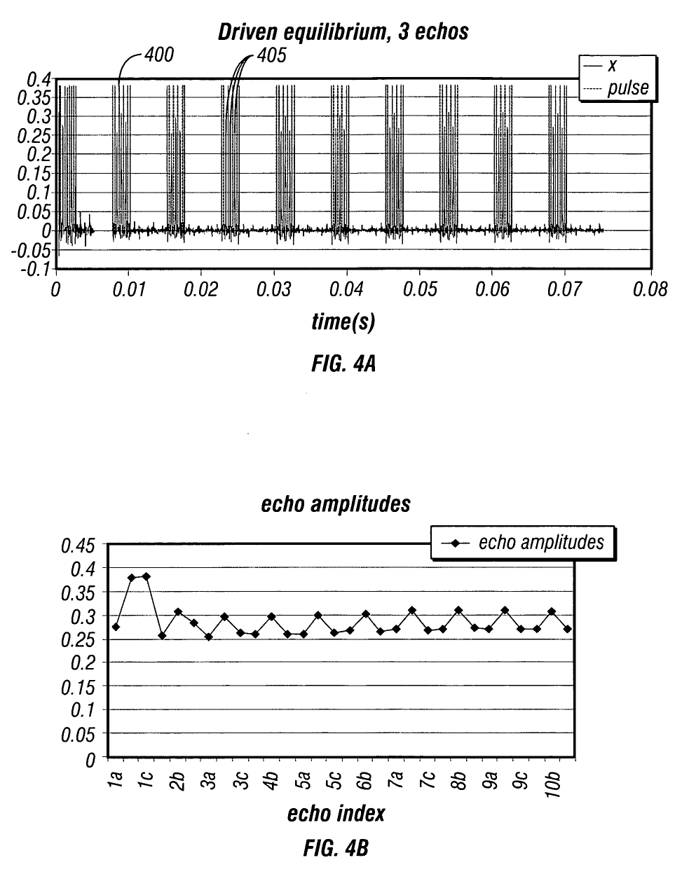

FIGS. 3-4 show simulations using a series of DE pulse groups obtained using an NMR simulation program. For the refocusing pulses, pulse lengths corresponding to 180° are not used. Instead, shorter pulse lengths, such as those used in an ORPS sequence, are implemented.

FIGS. 3A-B show spin echo responses to a series of DE pulse groups. Each DE pulse group is designed to give rise to one spin echo (e.g. the DE group of Eq. (3)). FIG. 3A shows an echo sequence with 10 such DE pulse groups 300. In FIG. 3A time is shown along the abscissa in seconds, and amplitude is shown along the ordinate in arbitrary units. The resultant spin echo magnetization values along the x-axis 305 are also shown. FIG. 3B shows echo amplitudes corresponding to each of the 10 DE pulse groups of FIG. 3A. As can be seen from FIG. 3B, the echo amplitudes, after an initial transition period, hardly vary at all.

Alternatively, it is possible to use DE pulse groups which give rise to more than one spin echo. Typically, in a CPMG sequence, the first spin echo does not achieve the full amplitude whereas the second spin echo is generally more representative of the maximum possible echo amplitude. FIGS. 4A-B show spin echo responses to a series of DE pulse groups, each designed to give rise to three spin echoes. At the time when the 4^{th} echo would appear, a 90₋ₓ pulse aligns the magnetization back along the z-axis. As expected, the second echo of each pulse sequence achieves a greater amplitude. It can be useful to obtain more than one echo by increasing the length of the driven equilibrium block.

FIG. 4A shows an echo sequence with 10 DE pulse groups 400 comprising 3 spin echoes each. In FIG. 4A time is shown along the abscissa in seconds and amplitude along the ordinate in arbitrary units as in FIG. 3A. Spin echo magnetization values along the x-axis 405 are shown. FIG. 4B shows echo amplitudes obtained with the DE pulse groups of FIG. 4A. The DE group index is shown along the abscissa. Letters a to c denote the first to third echoes of each DE group. The continuity of echo amplitudes can be seen. The arbitrary amplitude units of all the four FIGS. 3A/B and 4A/B are the same for the echo amplitudes. Comparing FIG. 4B with FIG. 3B we see that for the DE groups with 3 echoes all the echo amplitudes are greater than the average echo amplitude of FIG. 3B that produced one echo per DE group.

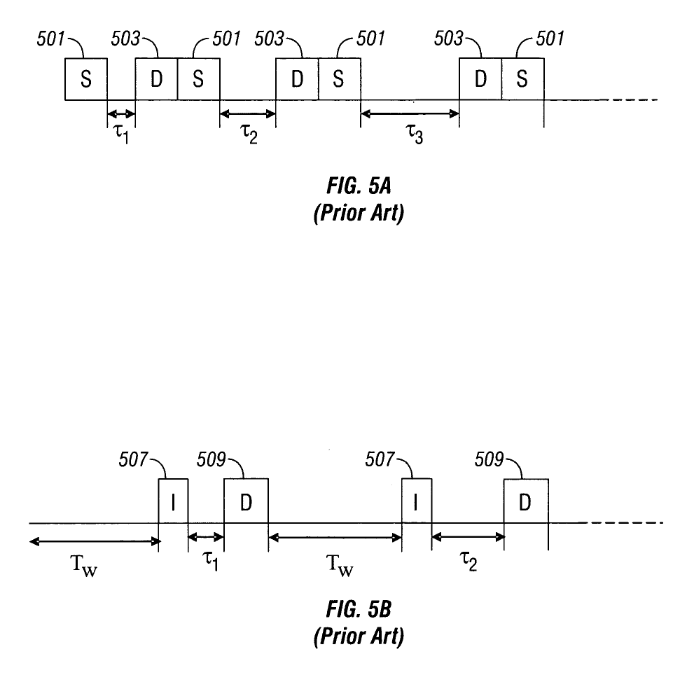

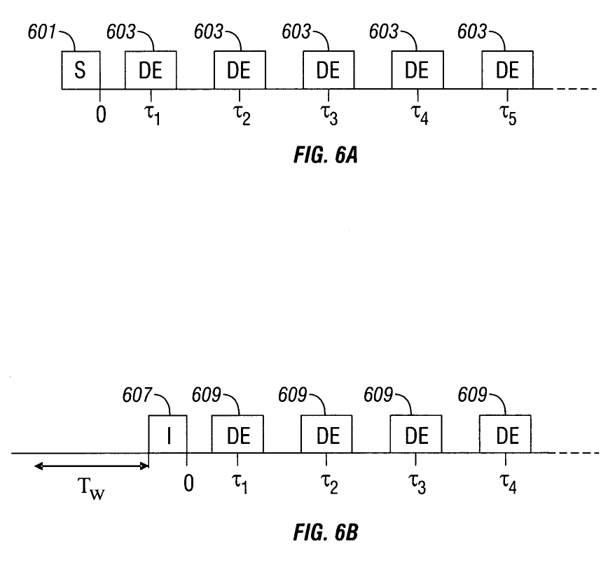

FIGS. 5-6 illustrate how the driven equilibrium sequence can be used to speed up T, measurements. FIG. 5A shows a pulse sequence usable for a conventional saturation recovery T₁ method. Blocks marked S (501) indicate a saturation sequence, e.g. aperiodic sequence (APS), and blocks marked D (503) denote a detection sequence, e.g. short CPMG or ORPS. τ₁, τ₂, τ₃ etc. are delay times. By plotting the detected signal amplitudes versus T₁ one can obtain a T₁ saturation recovery curve from which can be derived a T₁ distribution. By way of example three different τᵢ are shown in FIG. 5A but less or more are possible. Alternatively, FIG. 5B shows a pulse sequence usable for a conventional inversion recovery T₁ method. Blocks marked I (507) indicate an inversion sequence (e.g. 180° pulse or fast adiabatic sweep), and blocks marked D (509) denote a detection sequence, e.g. short CPMG or ORPS. τ₁, τ₂, etc. are delay times, and T_{W} is a wait time of sufficient length to achieve equilibrium magnetization. By way of example two τᵢ are shown in FIG. 5A but less or more are possible. Typically T_{W} is about 3 to 5 times the longest expected T₁. By plotting the detected signal amplitudes versus τ, one can obtain the T₁ inversion recovery curve, from which one can derive a T₁ distribution. The inversion recovery method for obtaining T₁ gives higher quality data than the saturation sequence (FIG. 5A) because the detected magnetizations span a range of two M₀ while the magnetizations using the saturation recovery span only one M₀, where M₀ is the equilibrium magnetization in the applied static magnetic field. However, the incorporation of wait times T_{W} in the inversion recovery method cause it to take much longer than the saturation recovery method.

Both the conventional saturation and inversion recovery methods have in common that after each sampling of the NMR signal on the recovery curve the recovery has to start from the beginning again. As the number of different τᵢ increases, these methods therefore become time-consuming.

Using driven equilibrium blocks enables one to obtain the NMR signal in less time. FIG. 6A shows a pulse sequence usable for a fast saturation recovery T₁ method. The block marked S (601) indicates a saturation sequence, e.g. aperiodic sequence (APS). Blocks marked DE (603) denote a driven equilibrium block. Each DE block detects one or more echoes and ends with magnetization in z direction. τ₁, τ₂, τ₃ etc. are the times at which the recovering magnetization is sampled. By plotting the detected signal amplitudes versus τ, one can obtain the T₁ saturation recovery curve, from which one can derive a T₁ distribution.

FIG. 6B shows a pulse sequence usable for a “fast” inversion recovery T₁ method. T_{w} indicates the wait time to reach equilibrium magnetization. The block marked I (607) indicates an inversion sequence (e.g. 180° pulse or fast adiabatic sweep), and blocks marked DE (609) denote a driven equilibrium block, detecting one or more echoes and ending with magnetization in z direction. τ₁, τ₂, τ₃ etc. are times at which the recovering magnetization is sampled. By plotting the detected signal amplitudes versus τ, one obtains a T₁ inversion recovery curve from which one can derive a T₁ distribution. A comparison of FIG. 6A to FIG. 5A shows a reduced time necessary for obtaining the measurement. Even more drastic is the comparison between FIG. 6B and FIG. 5B. We see that the use of DE blocks saves substantial measurement time for both, saturation recovery and inversion recovery.

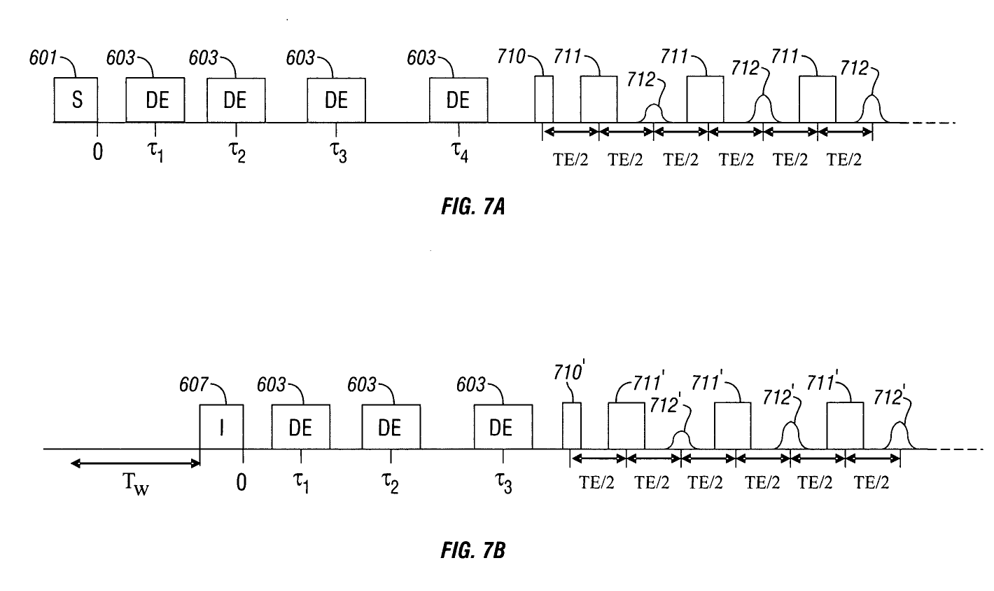

In many standard NMR measurements the sequence starts optionally with a saturation sequence followed by a long magnetization recovery wait time of several seconds followed by the ORPS (or CPMG) sequence to detect the signal and determine a T₂ decay. By inserting driven equilibrium blocks into the magnetization recovery wait time, it is possible to use the present magnetization recovery wait time to measure T₁ recovery (from which a T₁ distribution can be estimated) without extra time penalty. This is shown in FIGS. 7a and 7b.

FIG. 7a shows the fast saturation recovery sequence of FIG. 6a followed by a CPMG or ORPS sequence. 710 is an excitation pulse (typically 90°), 711 are the refocusing pulses (180° for CPMG, less than 180° for ORPS) and 712 are spin echoes. FIG. 7b shows the inversion recovery sequence of FIG. 6b followed by CPMG or ORPS sequence. 710′ is an excitation pulse (typically 90°), 711′ are the refocusing pulses (180° for CPMG, less than 180° for ORPS) and 712′ are spin echoes. The number of DE groups in FIGS. 7A and 7B may be more or less than those shown.

Once the T₁ and T₂ distributions have been obtained, they can be processed using prior art methods to determine parameters of interest of the earth formation and fluids in the earth formation. These parameters include porosity, clay bound water, bound water irreducible, bound water moveable, diffusivity and permeability

For a determination of a full T1 and T2 distribution the wait time with the DE blocks before the CPMG needs to be at least 3 to 5 times the longest expected T1 time. It is worth mentioning that the recovery sampled by the DE groups is strictly not governed by T1 relaxation alone but contains some contribution of T2 relaxation within each DE block In the same way the T2 measurement in the following CPMG is governed by a contribution of T1 relaxation too due to the inhomogeneous magnetic field and hence a stimulated echo contribution.

If the measurement sequence of [0038] is repeated several times with varying wait times (with or without) DE blocks this is called T1 editing (M. D. Hürlimann and L. Venkataramanan, J. Magn. Reson. 157, 31-42 (2002)). NMR data sampled in this way can be graphed three-dimensionally to show a T1-T2 distribution of the earth formation.

All the RF pulse sequences stated so far can be phase cycled to create a phase alternated pair (PAP) to remove acoustic and electronic ringing as well as signal offset. This technique is well known for the CPMG or ORPS sequence and is equally applicable to DE groups.

The NMR signals obtained from the echoes within the DE groups may be affected by motion of the NMR tool. Where the motion is known the signals may be corrected very similar to the method disclosed in U.S. patent application Ser. No. 10/918,965 filed on Aug. 16, 2004

The processing of the data may be accomplished by a downhole processor. Alternatively, measurements may be stored on a suitable memory device and processed upon retrieval of the memory device. Implicit in the control and processing of the data is the use of a computer program on a suitable machine readable medium that enables the processor to perform the control and processing. The machine readable medium may include ROMs, EPROMs, EAROMs, Flash Memories and Optical disks.

The invention has been described with an example of a MWD tool. The method is equally applicable to wireline applications in which the NMR tool is conveyed on a wireline. For wireline applications, all or part of the processing may be done at the surface or at a remote location. For wireline applications, the NMR tool is typically part of a downhole string of logging instruments.

While the foregoing disclosure is directed to the specific embodiments of the invention, various modifications will be apparent to those skilled in the art. It is intended that all such variations within the scope of the appended claims be embraced by the foregoing disclosure.

1. A method of evaluating an earth formation, the method comprising:
(a) applying a plurality of successive driven equilibrium (DE) pulse groups to the earth formation, each of the DE Pulse groups generating at least one echo signal; the plurality of DE pulse groups providing successive sampling of a longitudinal relaxation with a longitudinal time (T₁) distribution; and
(b) estimating the longitudinal relaxation time T₁ distribution of the earth formation using amplitudes of the at least one echo signal corresponding to the plurality of DE groups.

2. The method of claim 1 wherein the at least one echo signal comprises a plurality of echo signals.

3. The method of claim 1 wherein the DE pulse group is selected from the group consisting of:
(i) 90ₓ−τ−R_{y}−τ(echo)τ−R_{y}−τ−90₋ₓ
(ii) 90ₓ−τ−Rₓ−τ(echo)τ−Rₓ−τ−90₋ₓ,
(iii) a phase alternation of (i), and
(iv) a phase alternation of (ii).
where 90ₓ is a 90° tipping pulse having a first phase, R_{y} or Rₓ or R₋ₓ are refocusing pulses, τ is a time delay, and 90₋ₓ is a 90° tipping pulse having a second phase opposite the first phase.

4. The method of claim 1 wherein the plurality of DE groups are applied subsequent to a saturation sequence.

5. (canceled)

6. The method of claim 4 further comprising:
(i) applying at least one of (A) a CPMG sequence, and (E) an ORPS sequence after the plurality of DE groups; and
(ii) determining a transverse relaxation time T₂ of the earth formation.

7. The method of claim 1 wherein the plurality of DE groups are applied subsequent to an inversion sequence.

8. (canceled)

9. The method of claim 7 further comprising:
(i) applying at least one of (A) a CPMG sequence, and (B) an ORPS sequence after the plurality of DE groups; and
(ii) determining a transverse relaxation time T₂ of the earth formation.

10. The method of claim 6 further comprising estimating a parameter of interest selected from: (i) porosity, (ii) clay bound water, (iii) bound water irreducible, (iv) bound water moveable (v) diffusivity, and, (vi) permeability.

11. The method of claim 9 further comprising estimating a parameter of interest selected from: (i) porosity, (ii) clay bound water, (iii) bound water irreducible, (iv) bound water moveable (v) diffusivity, and, (vi) permeability.

12. An apparatus for evaluating an earth formation, the apparatus comprising:
(a) a nuclear magnetic resonance (NUR) tool which applies a plurality of driven equilibrium (DE) pulse groups to the earth formation, each of the DE pulse groups generating at least one echo signal, the plurality of DE pulse groups providing successive sampling of a longitudinal relaxation with a longitudinal time (T₁) distribution; and
(b) a processor which estimates the longitudinal relaxation time T₁ distribution of the earth formation using amplitudes of the at least one echo signal corresponding to the plurality of DE groups.

13. The apparatus of claim 12 wherein the at least one echo signal comprises a plurality of echo signals.

14. The apparatus of claim 12 wherein the DE pulse group is selected from the group consisting of:
(i) 90ₓ−τ−R_{y}−τ(echo)τ−R_{y}−τ−90₋ₓ.
(ii) 90ₓ−τ−Rₓ−τ(echo)τ−Rₓ−τ−90₋ₓ,
(iii) a phase alternation of (i), and
(iv) a phase alternation of (ii);
where 90ₓ is a 90° tipping pulse having a first phase, R_{y}, Rₓ and R₋ₓ are refocusing pulses, τ is a time delay, and 90₋ₓ is a 90° tipping pulse having a second phase opposite the first phase.

15. The apparatus of claim 12 wherein each of the plurality of DE pulse groups has a different delay time, the plurality of DE groups being applied subsequent to a saturation sequence.

16. (canceled)

17. The apparatus of claim 15 wherein the NMR tool applies at least one of (A) a CPMG sequence, and (B) an ORPS sequence after the plurality of DE groups.

18. The apparatus of claim 12 wherein the plurality of DE groups are applied subsequent to an inversion sequence.

19. (canceled)

20. The apparatus of claim 18 wherein the NMR tool further applies at least one of (A) a CPMG sequence, and (B) an ORPS sequence after the plurality of DE groups; and
wherein the processor further determines a transverse relaxation time T₂ of the earth formation.

21. The apparatus of claim 17 wherein the processor further estimates a parameter of interest selected from: (i) porosity, (ii) clay bound water, (iii) bound water irreducible, (iv) bound water moveable, (v) diffusivity, and, (vi) permeability.

22. The apparatus of claim 20 wherein the processor further estimates a parameter of interest selected from: (i) porosity, (ii) clay bound water, (iii) bound water irreducible, (iv) bound water moveable, (v) diffusivity, and, (vi) permeability.

23. The apparatus of claim 12 wherein the NMR tool comprises a gradient tool.

24. The apparatus of claim 12 further comprising a conveyance device which conveys the NMR tool into the borehole, the conveyance device selected from (i) a drillstring, and (ii) a wireline.

25. A machine readable medium for use with an apparatus for evaluating an earth formation, the apparatus comprising:
(a) a nuclear magnetic resonance (NMR) tool which applies a plurality of driven equilibrium (DE) pulse groups to the earth formation, each of the DE pulse groups generating at least one echo signal, the plurality of DE pulse groups providing successive sampling of a longitudinal relaxation with a longitudinal time (T₁) distribution;
the medium including instructions which enable a processor to:
(b) estimate a longitudinal relaxation time T₁ distribution of the earth formation using amplitudes of the at least one echo signal corresponding to the plurality of DE groups.

26. (canceled)

27. The medium of claim 25 selected from the group consisting of: (i) a ROM, (ii) an EPROM, (iii) an EAROM, (iv) a flash memory, and (v) an optical disk.
